(19) United States
(12) Patent Application Publication
(10) Pub. No.: US 2019/0044470 A1
(43) Pub. Date: Feb. 7, 2019

(54) THERMORADIATIVE CELL DEVICES AND SYSTEMS

(71) Applicant: X Development LLC, Mountain View, CA (US)

(72) Inventors: Martin Schubert, Mountain View, CA (US); Michael Grundmann, San Jose, CA (US); Cyrus Behroozi, Menlo Park, CA (US); Gregory Whiting, Menlo Park, CA (US)

(21) Appl. No.: 15/712,973

(22) Filed: Sep. 22, 2017

Related U.S. Application Data
(60) Provisional application No. 62/541,875, filed on Aug. 7, 2017.

(51) Int. Cl. H02S 10/30; H02S 10/20

(52) U.S. Cl. CPC H02S 10/30; H02S 10/40; H02S 10/20

(57) ABSTRACT

The present technology provides power generation using thermoradiative cell (TRC) structures, which generate electricity by radiating heat from a hotter area/body to a cooler area/body. The TRC structures may be used in conjunction with photovoltaic (PV) cells on a common platform as a power generation system. In some scenarios, the platform may be a high altitude platform (HAP). Here, the TRC structures may be arranged or aligned to radiate heat towards space or otherwise in a direction generally away from the Earth's surface. The electricity generated by the TRC structures is provided to a power supply, for instance to recharge batteries of the power supply. The TRC structures may be intersubband TRC structures. In some configurations, the TRC structures are co-located on the same side of a panel as the PV cells. In other configurations, the TRC structures are remote from the PV cells.

### CROSS-REFERENCE TO RELATED APPLICATIONS

The present application claims the benefit of the filing date of U.S. Provisional Patent Application No. 62/541,875 filed Aug. 7, 2017, the disclosure of which is hereby incorporated herein by reference.

### BACKGROUND

Devices such as satellites and other high altitude platforms need on-board power so that their payloads can perform required operations, which may include providing telecommunications, weather measurements or other services. On-board power supplies are typically size constrained, and are limited in terms of how much power can be supplied at a given point in time and over the lifetime of the device. It is possible to generate power on site, for instance via photovoltaic (PV) cells. However, such on-board generation may be limited by environmental conditions, for instance when the sun is shining directly on the PV cells. At other times, the device may not be capable of generating sufficient power for the payload.

### BRIEF SUMMARY

Aspects of the disclosure involve providing supplemental power generation for high altitude platforms (HAPs), including atmospheric or space-based HAPs. Such platforms can include, by way of example only, stratospheric balloons or other inflatable structures, drones or aircraft, such as unmanned aerial vehicles (UAVs), as well as satellites in orbit around the Earth. The supplemental power generation employs thermoradiative cells (TRCs). In particular, TRCs generate electric power by “negative illumination”, whereby heat is radiated from a hotter area/body to a cooler area/body. The TRCs may be incorporated with or otherwise complement PV cells on the platforms.

In accordance with aspects of the disclosure, a high altitude platform is configured to operate in the stratosphere or space. The platform includes a payload, a power supply coupled to the payload to provide power thereto, and a control system coupled to the payload and the power supply. The control system is configured to manage operation of the payload and to manage recharging of the power supply. The platform also includes a power generation system coupled to the control system and the power supply. The power generation system comprises a photovoltaic (PV) structure and a thermoradiative cell (TRC) structure. The PV structure is arranged on a panel of the platform and is configured to generate power by converting light into electricity. The TRC structure is configured to generate power by radiation of heat into space or the stratosphere.

In one example, the PV structure and the TRC structure are disposed on a first side of the panel. Here, in one scenario the first side of the panel includes at least one of a photonic crystal structure and a dichroic beam splitter configured to selectively direct light to one or both of the PV structure and the TRC structure. In another scenario, the PV structure covers at least 70% of the surface area of the first side of the panel, and the TRC structure covers no more than 30% of the surface area of the first side of the panel.

A first portion of the PV structure may be backed by a back reflector and a second portion of the PV structure may be backed by the TRC structure. The PV structure may be a thin film PV cell structure, and the TRC structure is arranged on a side of the PV structure opposite from a light receiving side of the PV structure.

In a further scenario, the TRC structure is an intersubband TRC structure having an asymmetric current transport characteristic. In this case, the intersubband TRC structure may be selected to provide transparency between a transition edge of the intersubband TRC structure and an absorption edge of the PV structure.

In another alternative, the PV structure is disposed on a first side of the panel and the TRC structure is disposed on a second side of the panel opposite the first side. Here, the control system may be configured to manage operation of the power generation system so that during a daylight condition the PV structure is arranged to point in space towards the sun and during a nighttime condition the TRC structure is arranged to point towards space. In an alternative, the platform further comprises an alignment mechanism. In this case, the control system is configured to direct the align mechanism to place the second side of the panel towards space. In yet another alternative, the second side of the panel includes one or more low-emissivity regions that intersperse or surround the TRC structure.

The TRC structure and the PV structure may comprise a current-matched circuit of the power generation system. Or the TRC structure and the PV structure may comprise separate circuits of the power generation system, which independently couple to the power supply.

In one variation, the TRC structure is indirectly coupled to an external environment. In this case, the platform may further include an optical fiber that indirectly couples the TRC structure to the external environment. Here, the TRC structure may be selected to have a predetermined optical mode density for coupling via the optical fiber.

According to other aspects, the TRC structure may be arranged adjacent to at least one of the payload, the control system and the PV structure to operate as a heat sink therefor.

The high altitude platform may be selected from the group consisting of a satellite, a high altitude balloon system, a drone and a piloted aircraft.

In accordance with other aspects of the disclosure, a method of generating power for a high altitude platform is provided. The method comprises obtaining, by one or more processors of a control system, status information from an on-board power supply of the high altitude platform. The method includes determining, by the one or more processors, whether supplemental power generation is available from an on-board power generation system coupled to the control system and the power supply. The power generation system comprises a photovoltaic (PV) structure and a thermoradiative cell (TRC) structure. The PV structure is arranged on a panel of the high altitude platform and is configured to generate power by converting light into electricity. The TRC structure is configured to generate power by radiation of heat into space or the stratosphere. Upon determining that supplemental power generation is available, the method includes the one or more processors commencing recharging of the on-board power supply from at least the TRC structure of the power generation system.

In an example, the method further comprises aligning the TRC structure so that a heat emission surface of the TRC structure is directed towards space or otherwise away from a surface of the Earth.

### BRIEF DESCRIPTION OF THE DRAWINGS

FIG. 1 illustrates a high altitude platform communication system in accordance with aspects of the disclosure.

FIGS. 2A-C illustrate examples of high altitude platforms in accordance with aspects of the disclosure.

FIG. 3 is a system block diagram of a high altitude platform communication system in accordance with aspects of the disclosure.

FIG. 4 illustrates an example control subsystem for use with high altitude platforms in accordance with aspects of the disclosure.

FIG. 5 illustrates a TRC and a PV arrangement in accordance with aspects of the disclosure.

FIG. 5A illustrates an example dual-sided TRC/PV arrangement in accordance with aspects of the disclosure.

FIG. 6 illustrates a back side of a PV panel in accordance with aspects of the disclosure.

FIG. 6A illustrates daytime and nighttime operations for a TRC and PV arrangement in accordance with aspects of the disclosure.

FIG. 6B illustrates a dichroic beam splitter used in conjunction with an integrated TRC/PV structure in accordance with aspects of the disclosure.

FIG. 6C illustrates an integrated TRC/PV structure with a photonic crystal in accordance with aspects of the disclosure.

FIG. 7 illustrates a front side of a PV panel in accordance with aspects of the disclosure.

FIGS. 7A-7D illustrate planar and stacked TRC/PV arrangements in accordance with aspects of the disclosure.

FIG. 8 is an example flow diagram showing a power supply recharging process in accordance with aspects of the disclosure.

### DETAILED DESCRIPTION

### Overview

There are various aspects and configurations of TRC-based supplemental power supply which may be employed in HAPs, depending on the type of platform, engineering constraints and environmental or other conditions. Examples of such arrangements are described below, and are illustrated in the accompanying drawings. The TRCs may be incorporated with or otherwise complement PV cells on the platforms.

Example Systems

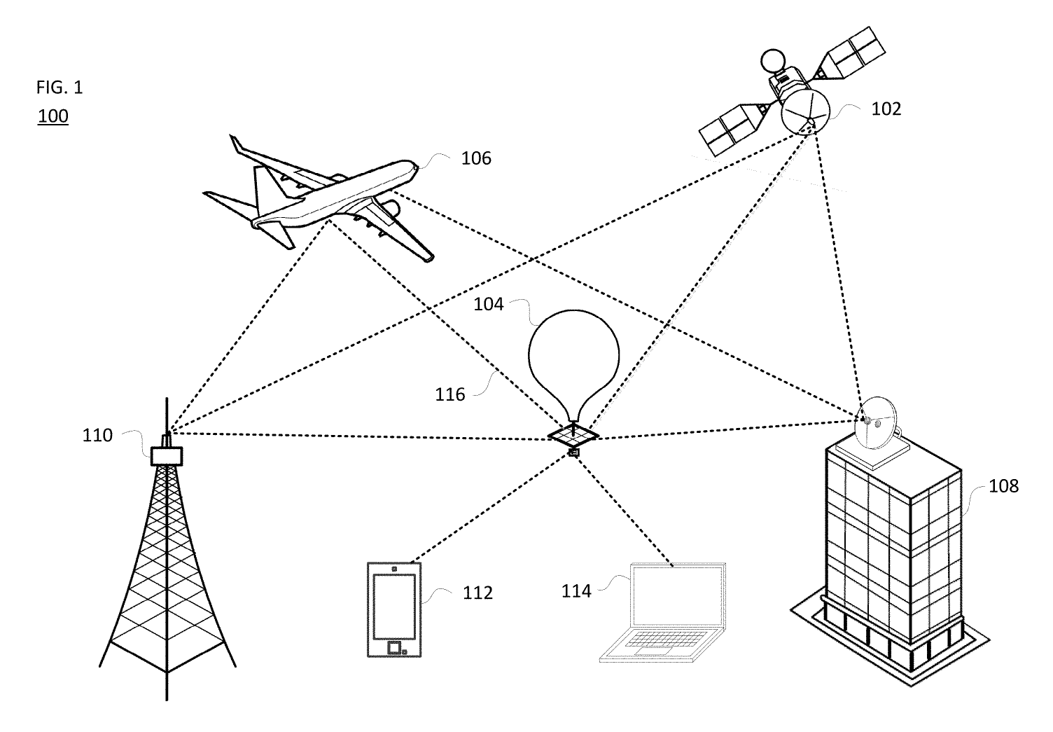

FIG. 1 illustrates an exemplary communication system 100 that includes various HAPs, including a satellite 102, a high altitude balloon system 104 and a drone or other aircraft 106. The HAPs may provide, for instance, direct and/or indirect communication links with ground stations such as ground station 108, cell towers such as cell tower 110, and client devices such as client devices 112 and 114. Wireless connectivity between different devices in the system is shown by dotted lines 116.

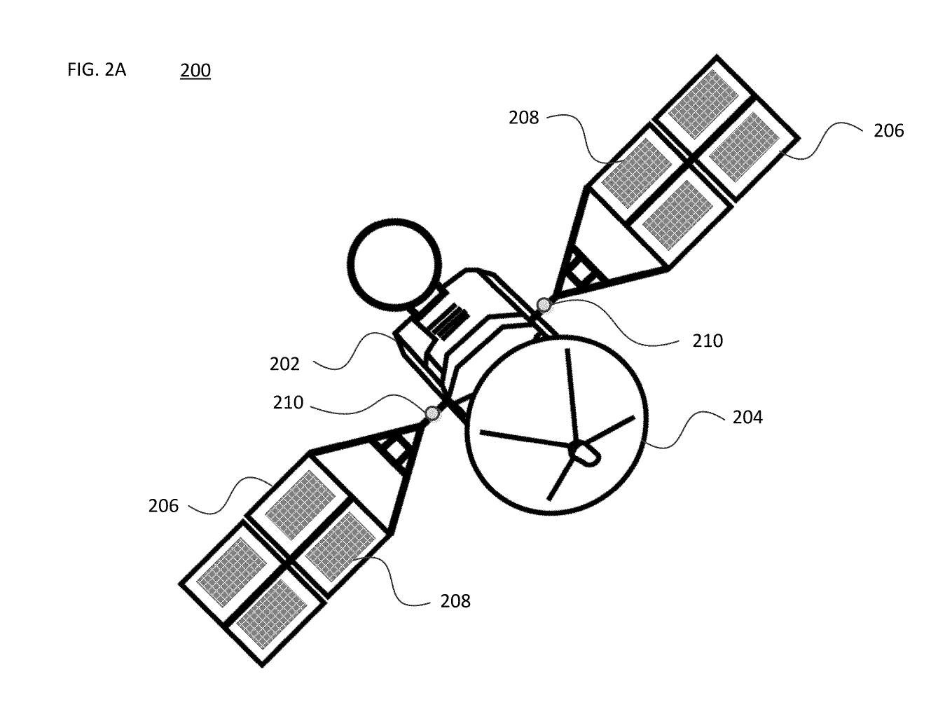

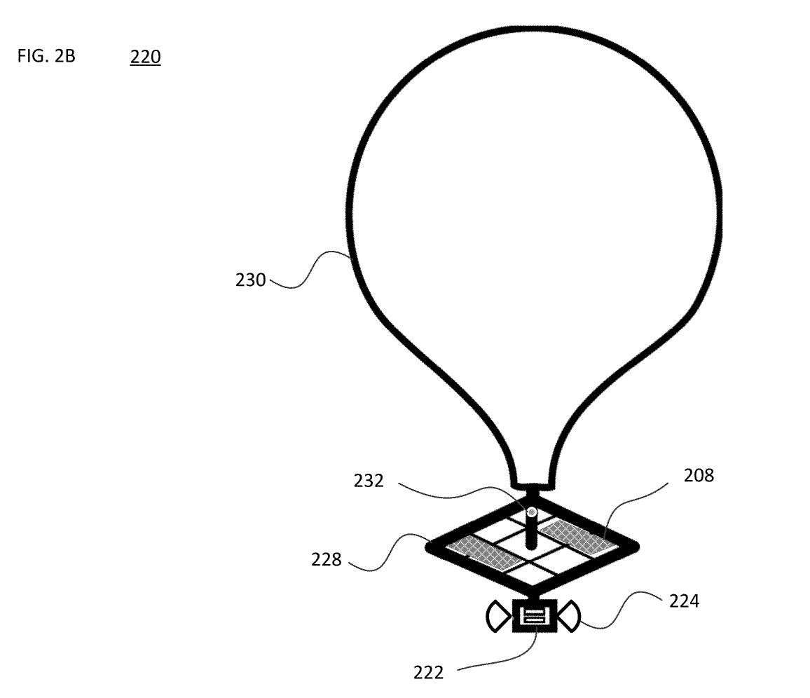

FIGS. 2A-C illustrate examples of the satellite 102, high altitude balloon system 104, and aircraft 106 incorporating aspects of the technology. For instance, as shown in FIG. 2A, satellite 200 includes a payload section 202, a communication section 204 and power generation sections 206. In some instances, the communication section 204 may be part of the payload section 202. Each power generation section 206 includes one or more TRC structures 208. The satellite 200 may also include one or more adjustment mechanisms 210, such as gimbals, to adjust the relative orientation of the TRC structures 208. As shown in FIG. 2B, high altitude balloon system 220 includes a payload section 222, a communication section 224, a power generation sections 226 having one or more TRC structures 228, and a balloon 230. The high altitude balloon system 220 may also include one or more adjustment mechanisms 232, such as a gimbal, to adjust the relative orientation of the TRC structures 228. And as shown in FIG. 2C, aircraft 240 includes one or more TRC structures 242. Here, the payload, communication section and power generation sections are not illustrated, and may be located within the aircraft 240.

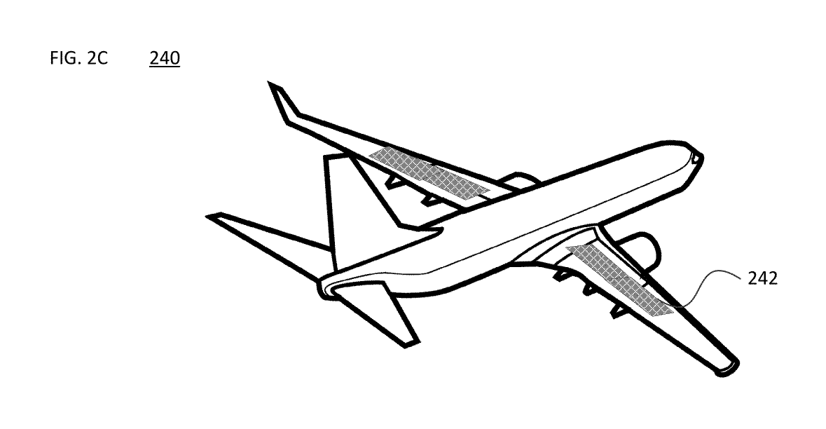

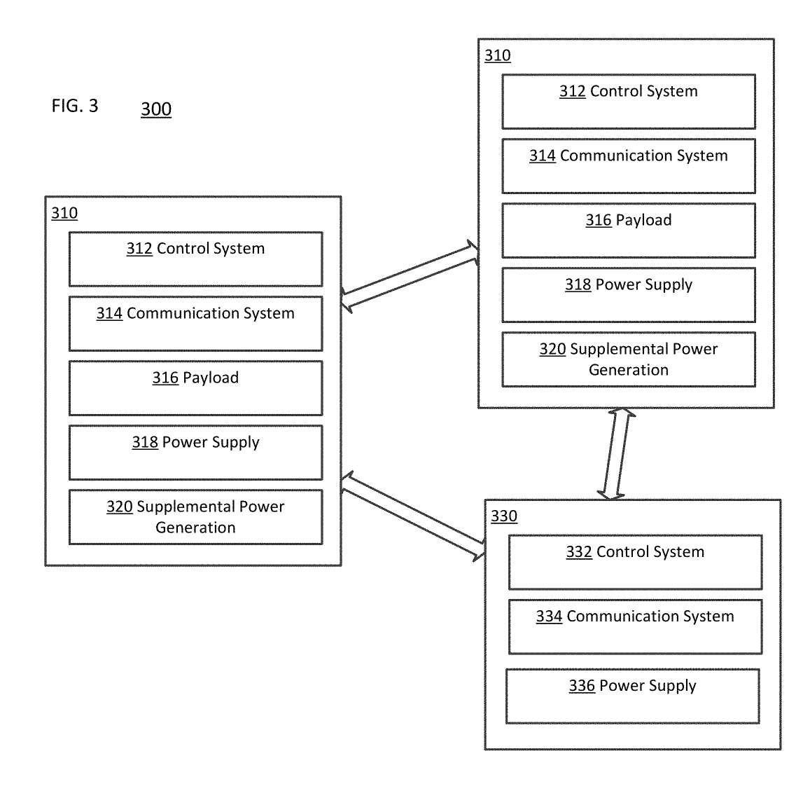

FIG. 3 illustrates a system block diagram 300 that includes a pair of HAPs 310 and a control station 330, such as a ground control station or communication switching center. As shown, each HAP 310 includes a control system 312, a communication system 314, a payload 316, a power supply 318 and a supplemental power generation arrangement 320. The control system 312 manages the overall operation of the HAP 310 and the various other subsystems.

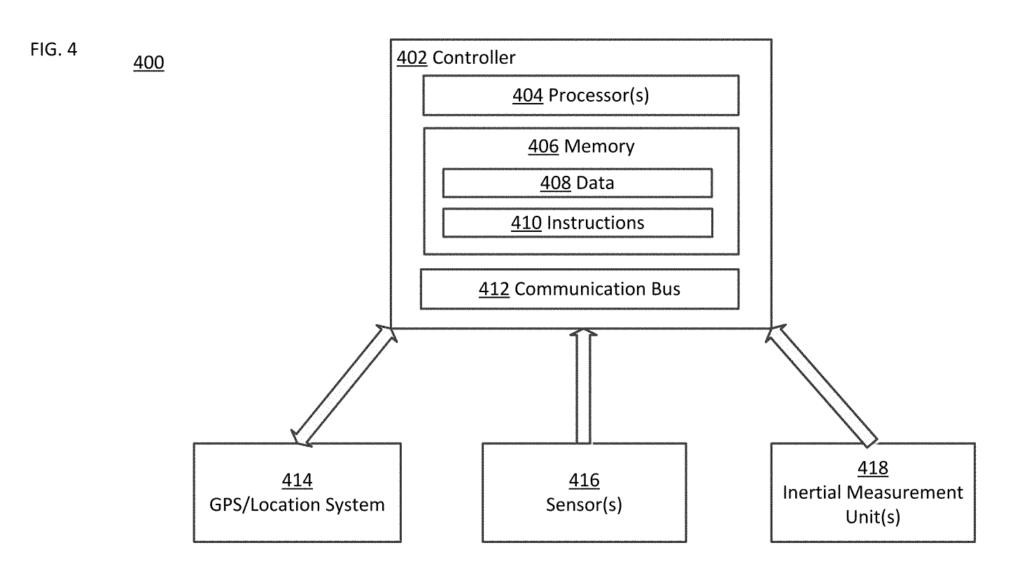

FIG. 4 illustrates an example 400 of control system 312. This figure shows a system controller 402 operatively coupled with a GPS or other location system 414, one or more sensors 416, as well as one or more inertial measurement units 418. The system controller 402 may be a computer having one or more processors 404, a memory 406, and a communications bus 412. Although some functions described below are indicated as taking place on a single computer having a single processor, various aspects such as control of the supplemental power generation arrangement can be implemented by a plurality of computers, for example, communicating information over a wired and/or wireless link via the communication bus 412.

The one or more processors 404 may be any conventional processors, such as commercially available CPUs. Alternatively, the one or more processors may be a dedicated device such as an application specific integrated circuit (ASIC) or other hardware-based processor, such as a field programmable gate array (FPGA). Although FIG. 4 functionally illustrates the one or more processors 404 and memory 406 as being within the same block, it will be understood that the one or more processors 404 and memory 406 may actually comprise multiple processors and memories that may or may not be located within the same physical subsystem of the HAP. Accordingly, references to a processor or computer will be understood to include references to a collection of processors or computers or memories that may or may not operate in parallel.

Memory 406 stores information accessible by the one or more processors 404, including data 408 and instructions 410 that may be executed by the one or more processors 404. The memory may be of any type capable of storing information accessible by the processor, including a computer-readable medium such as a hard-drive, memory card, ROM, RAM, optical disks, as well as other write-capable and read-only memories. Data 408 may be retrieved, stored or modified by the one or more processors 404 in accordance with the instructions 410. Instructions 410 may be any set of instructions to be executed directly (such as machine code) or indirectly (such as scripts) by the one or more processors 404. For example, the instructions 410 may be stored as computer code on the computer-readable medium. In that regard, the terms “instructions” and “programs” may be used interchangeably herein. The instructions 410 may be stored in object code format for direct processing by the one or more processors 404, or in any other computer language including scripts or collections of independent source code modules that are interpreted on demand or compiled in advance.

Returning to FIG. 3, the communication system 314 provides external communication with other HAPs, the control station 330, and other devices such as client devices. For instance, the communication system 314 may provide RF and/or optical communication with remote devices. Each communication stream may be one way or bidirectional. The payload 316 may include one or more sensors, such as atmospheric sensors, as well as other equipment to take measurements of the HAP's surroundings. As noted above, the payload 316 may also include the communication system 314, or the payload may be the communication system itself.

Each HAP 310 preferably includes an on-board power supply subsystem 318. This may comprise one or more batteries capable of powering the control system 312, communication system 314 and/or the payload 316. Supplemental power generation subsystem 320 is operatively connected to the power supply 318, and is configured to generate power, for instance to recharge the batteries of the power supply subsystem 318. The supplemental power generation subsystem 320 includes one or more TRCs, preferably employed in combination with a PV cell array.

Also shown in FIG. 3 is control station 330. As with the HAPs, the control station 330 includes a control system 332 for managing overall operation of the control station 330, as well as a communication system 334 configured to communicate with the HAPs 310. The communication system 334 is also capable of communication with Earth-based devices, such as cellular telephone towers, mobile switching centers, WiFi access points and client devices such as mobile phones, laptops, tablet computers, wearable computing devices and the like. The control station 330 may also include a power supply 336; however, the control station 330 may alternatively receive power from an external source. And in the situation where the control station 330 is itself a HAP, it may also include a supplemental power generation subsystem (not shown).

Example Configurations

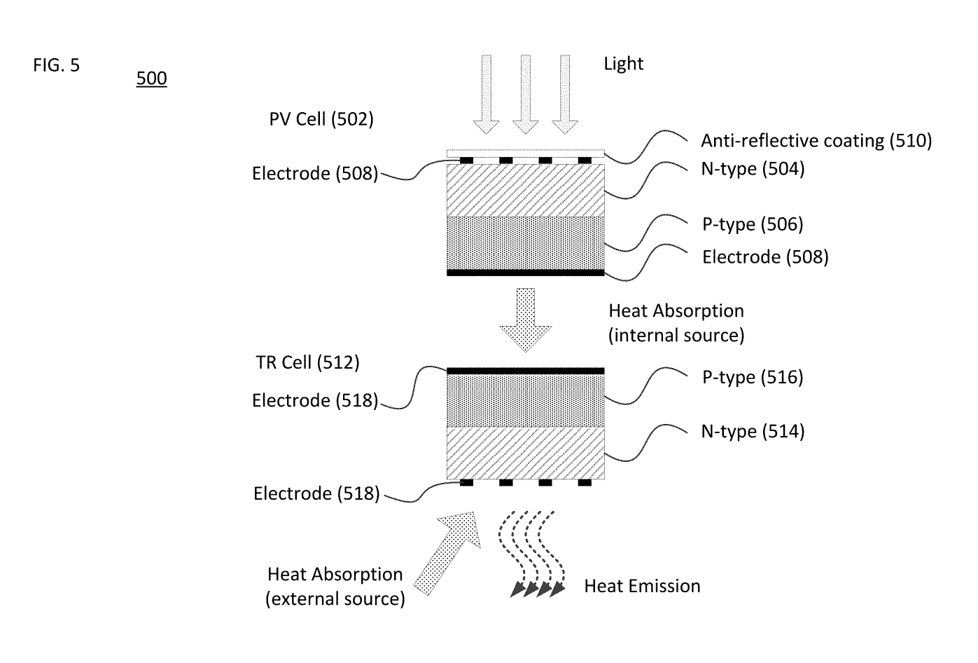

FIG. 5 illustrates an example TRC structure 500 for use in supplemental power generation according to aspects of the disclosure. As shown, the structure 500 includes both a TRC and a PV cell. The PV cell 502 includes N-type material 504 and P-type material 506 sandwiched between electrodes (contacts) 508. An anti-reflective coating (510) overlays the side of the PV cell that is arranged to face a light source such as the sun. Other components (not shown) may include a cover glass, focusing lens, diffraction grating, etc. The PV cell 502 is configured to generate an electric current from the received light.

TRC 512 includes N-type material 514 and P-type material 516 sandwiched between electrodes (contacts) 518. Preferably the intersubband transition is within a range of, e.g., 0.02 to 0.05 eV or 0.05 eV to 0.5 eV. Examples of such materials include GaAs, InGaAs, and heterostructures, as well as AlInGaAs, AlGaInN, AlInGaP, etc., direct bandgap materials and heterostructures of InSb and GaSb may also be used. The various materials may comprise direct 3D semiconductors as well as stacks of thin film or 2D semiconductors with a bandgap tailored by the stack-up thickness of the various layers.

As noted above, TRCs generate electric current by radiating heat from a hotter area/body to a cooler area/body. By way of example, as illustrated in FIG. 5 the TRC may absorb heat from an external source or an internal source. In the context of a HAP, the external source may be the sun or the Earth. The internal source may be PV cell 502, a portion of the HAP payload, the control system or other components of the HAP. In this case, the TRC 502 may act as a heat sink for the on-board HAP component(s). As discussed further below, the relative placement of the TRC with respect to the PV cell may vary depending on the type of HAP, system power, weight and architecture requirements, as well as other restrictions.

For instance, in a first TRC configuration that is particularly beneficial for space-based platforms, the back side of a panel of PV cells includes the TRC components. An example of this is shown in FIG. 5A. The PV panel is oriented towards the sun at least during daylight operation to generate electricity from captured light rays 520. Ideally, the PV panel is as efficient as possible at converting sunlight into electricity. Thus, in the ideal case, the PV panel does not radiate in the sub-bandgap regime. However, the PV panel may heat up, for instance due to a mismatch of absorbed photon energy and the PV bandgap. Arranging the TRC on the other side of the panel enables the TRC to act as a heat sink for the PV cell, generating electric power by radiating (excess) heat 522 into space. The orientation of the TRC relative to a cooler body (e.g., a space-facing side of the HAP) may be adjusted by the control system as discussed below.

In this and other examples herein, the PV and TRC may be part of a single circuit, for instance a current-matched circuit. Alternatively, the PV and TRC may be configured to operate as separate systems. Both the current-matched circuit and the separate systems may be controlled by the control system, for instance to recharge batteries of the power supply.

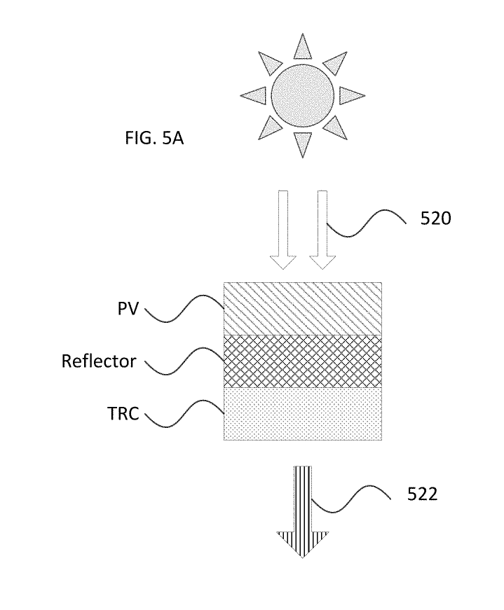

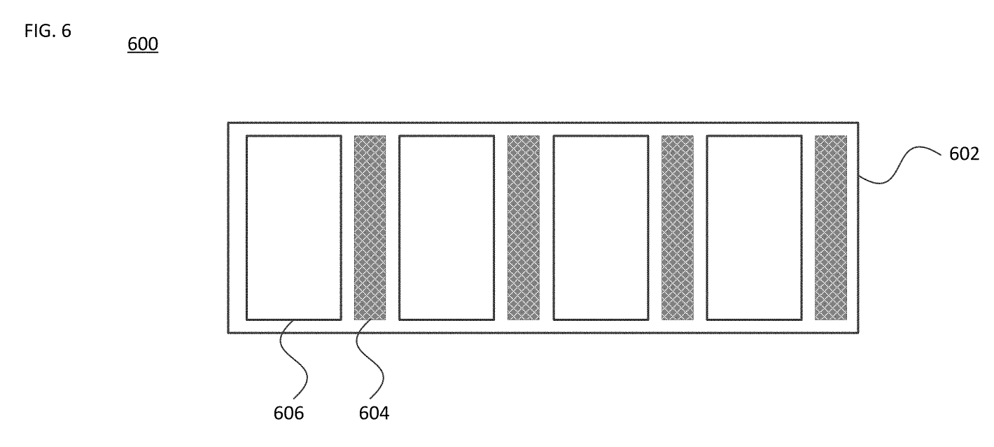

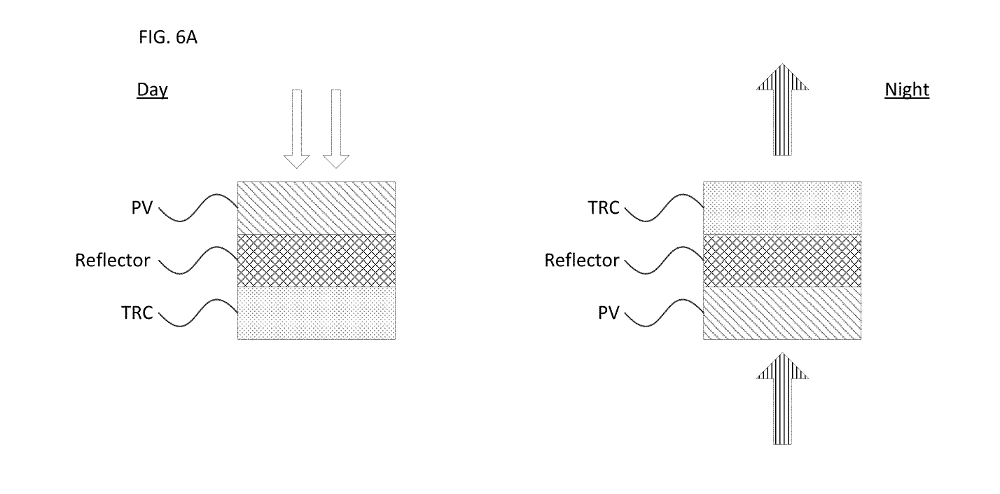

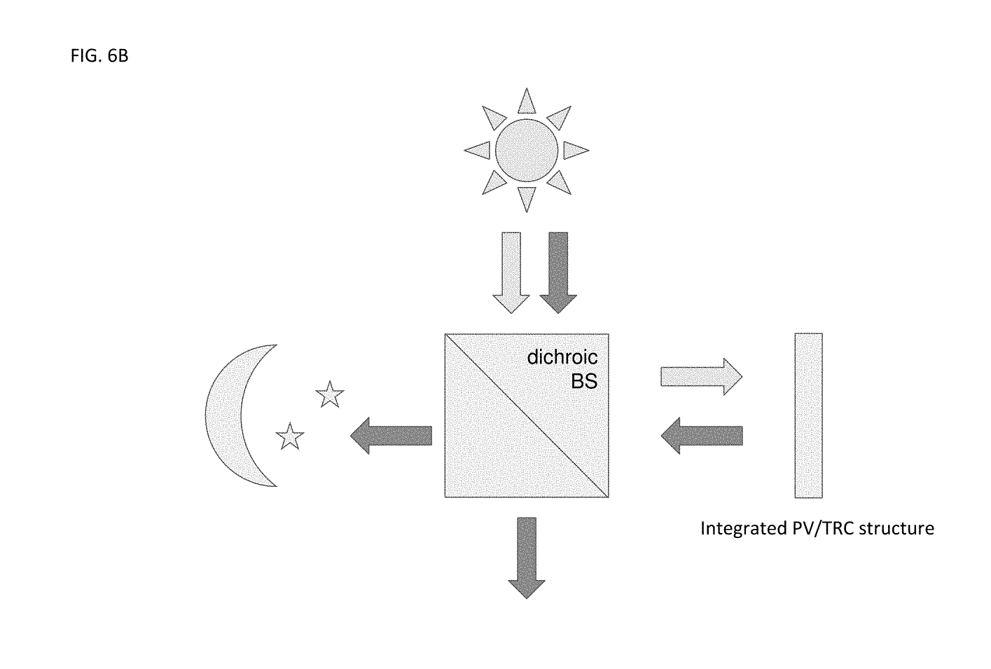

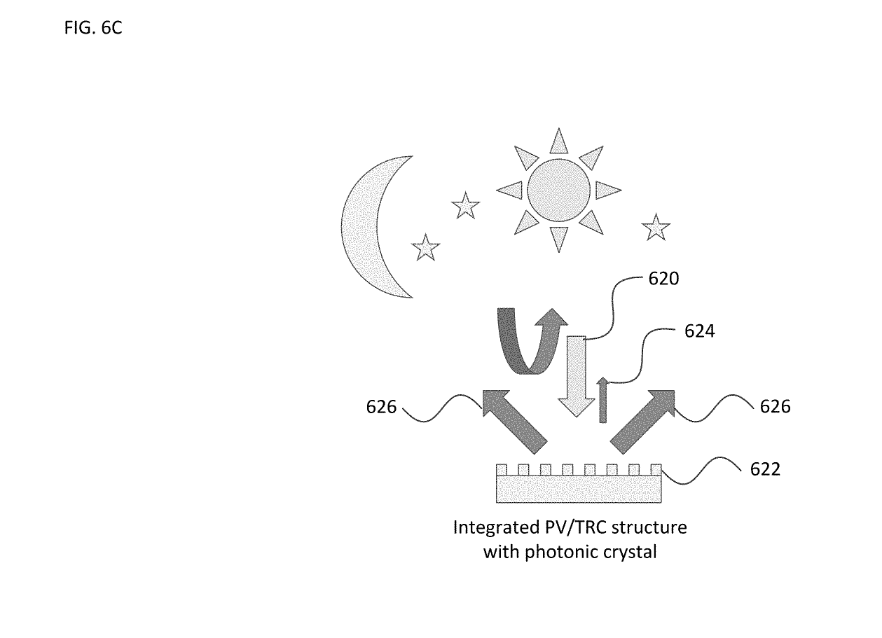

For one arrangement 600 as illustrated in FIG. 6, back 602 of the PV panel has one or more sparse TRC regions 604 adjacent to or surrounded by low-emissivity regions 606. Electrodes and other components are not shown. In this case, the TRC regions may have rough surfaces, while the low-emissivity regions are smoother, generally planar regions which may be formed of or coated with aluminum or other material. In another configuration, the regions could have tunable emissivity over the grid to tune the temperature and radiation. Here, phase-change materials, gratings and similar components may be employed. This helps to increase the temperature and the efficiency of the TRC operation. The rough surfaces may be formed from shaping the semiconductor material, depositing additional material layers, or attaching other structures onto the TRC regions. Other materials that may be used in the low-emissivity regions besides aluminum include, by way of example only, gold, silver, copper, palladium, platinum, including any alloys thereof. In addition to this, multilayer structures, e.g. metal with a dielectric interlayer, can be employed as well.

A second configuration is relevant to the day v. night situation, and may be of particular use for long-duration stratospheric HAPs, such as high altitude balloons intended to remain aloft for days, weeks or months at a time. Here, similar to the first configuration, the TRC may be positioned on a back side of the PV panel. In this arrangement, as the PV panel absorbs light from the sun, the TRC is able to absorb thermal energy from the Earth and/or from onboard components, as well as from the PV panel itself. For the TRC to efficiently generate power it should be pointed towards the cold of space. In order to achieve this, an adjustment mechanism such as a gimbal may be employed, so that at night the TRC can be pointed away from the Earth and towards space. FIG. 6A illustrates cross-sectional views showing exemplary daytime and nighttime operation. As shown on the left, in the daytime light is directed onto the PV panel. In this circumstance, thermal radiation originating from the earth is negligible compared to solar irradiance. And as shown on the right, at night the orientation is flipped. Here, the backside TRC structure is warmed by thermal radiation from the Earth. The TRC faces the cold of space, and the radiation imbalance results in the generation of power. As illustrated, a reflector element may be interposed between the PV panel and the TRC. Example gimbal-type adjustment mechanism 210 and 232 are shown in FIGS. 2A and 2B, respectively, although other devices and systems for orienting the TRC as desired may be employed.

In a variant, the TRCs may be arranged on the same side of the panel as the PVs. Here, the TRCs are able to absorb heat from the sun (and potentially from the PVs) during the daytime, and re-radiate heat back towards space, both by day and at night. This may also simplify manufacture and reduce costs. However, it may be beneficial to engineer the emission profile of the TRC to minimize radiation coupling from the sun. By way of example, photonic crystals or dichroic optical elements may be applied to the panel to achieve the desired emission profile. In one example, a dichroic beam splitter may be used to allow radiation absorbed by the PV to reach the panel surface, while longer wavelengths are redirected and prevented from reaching the panel surface. Consequently, long-wavelength radiation from the TRC will not couple to the sun, resulting in more efficient operation. In another implementation, photonic crystal structures can be selected which yield peak emission/absorption in a non-normal direction, achieving a similar behavior to the dichroic beamsplitter.

During the day, the TRC generates power by radiating into the cold of space. FIG. 6B illustrates one arrangement employing a dichroic beam splitter (BS). As shown in this figure, the dichroic beam splitter reflects wavelengths that are absorbed by the PV but transmits wavelengths that are emitted by the TRC. The TRC couples to the cold of space, while the PV has a view of the sun. In an alternative, the transmission and reflection can be reversed. FIG. 6C illustrates a different arrangement in which a photonic crystal structure is part of the integrated PV/TRC panel. Here, the photonic crystal (or equivalent material) modifies the coupling of the TRC to free space optical modes, so that for thermal radiation there is a “blind spot” in place of the sun. The TRC can generate power when there is a net outbound photon flux. Sunlight 620 shines on the photonic crystal 622. Normally-incident thermal radiation from the sun 624 is reflected, and the TRC emits thermal radiation 626 when the net outbound flux exists.

At night there is no need to gimbal or otherwise adjust the orientation of the panel. Another variant directs or siphons thermal energy from the payload, control system or other components to the TRC. In this case, a heat pipe or other thermal conduit may be used to connect the TRC to the component, or the TRC may be placed adjacent or otherwise coupled to the heat-generating component. Depending on the platform, this may enable the engineers to design the payload housing for more efficient placement of components. It could also eliminate the need for dedicated heat sink devices in the platform. This could result in important weight and space savings, which are particularly beneficial for HAP systems.

Another configuration utilizes an indirect connection of the TRC to the cooler area/body (e.g., space). Here, an optical path, such as an optical fiber, acts as the coupling between the TRC and cold reservoir. This enables the TRC to be placed closer to the payload. Factors that impact selection of particular structures and configurations include a desirability that the fraction of optical modes that couple into the fiber be large, and that the total number of optical modes that couple into the fiber is large. Structures such as gratings may be employed to create a high optical mode density and enhance coupling efficiency into the optical fiber. In general, metals or other high-index materials can be employed in various configurations, such as sheets, structured gratings, nanospheres, etc.

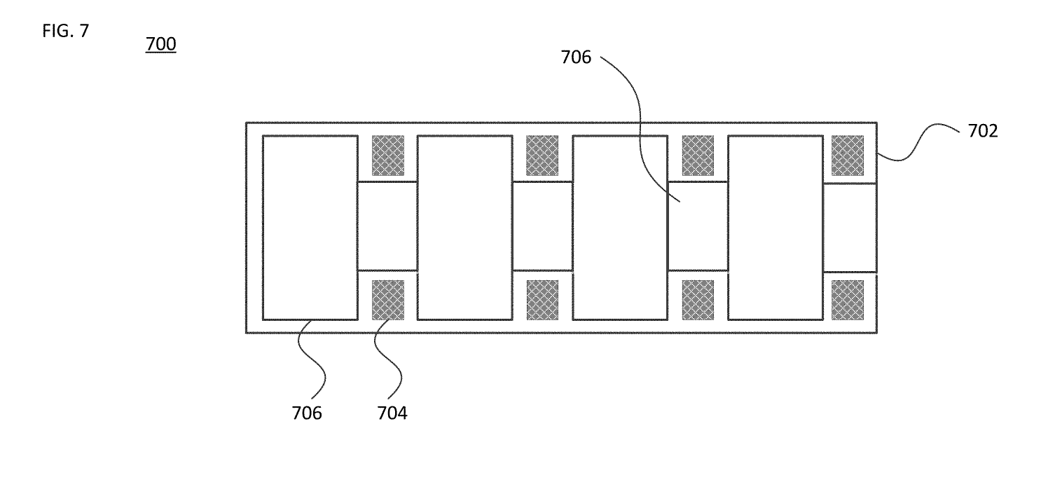

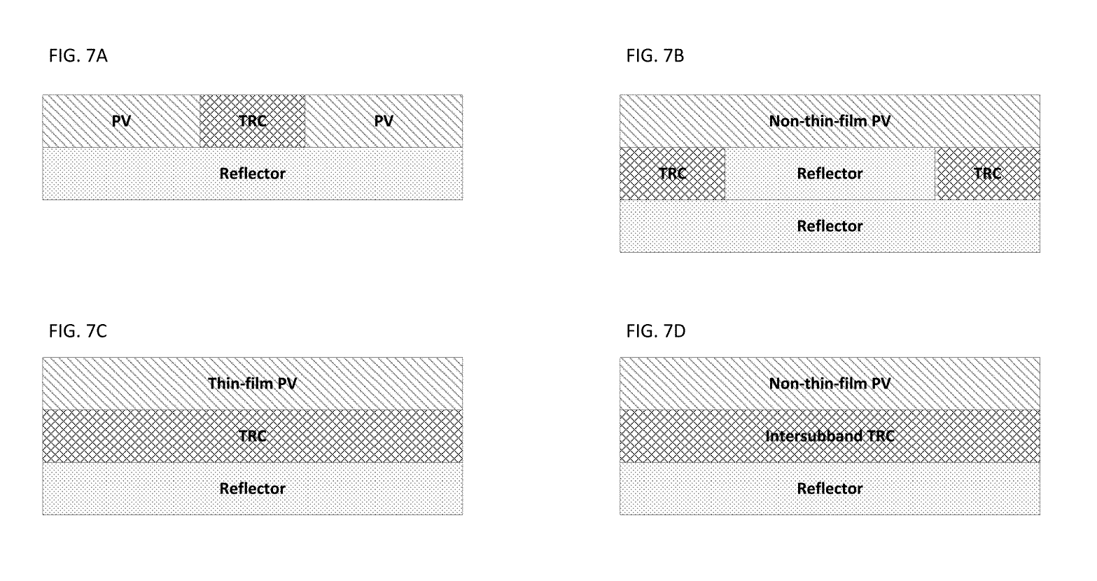

Depending on the arrangement, there may be current matching between the PV and TRC or they could function independently as noted above. For instance, a coplanar arrangement has a panel comprising mostly PV elements, with some (small) areas of TRC. FIG. 7 illustrates a coplanar arrangement 700 on a front side of PV panel 702. This arrangement includes sparse TRC regions 704 adjacent to or the PV cells 706. Electrodes and other components are not shown. In one example, the PV cells encompass approximately 90% of the surface area and the TRC regions encompass approximately 10% of the surface area. In another example, the surface area of the PV cells is between about 70-99% of the area, while the TRC regions make up about 1-30% of the area. In a further example, the TRC regions cover at least 20% of the surface area while the PV cells cover no more than 80% of the surface area. FIG. 7A shows one example of a coplanar PV-TRC structure with a back reflector element.

In accordance with a further arrangement, a sparse stacked structure is employed, for instance as shown in the example of FIG. 7B. Here, the PV cell is formed on one surface of the panel. The PV is partially backed by a back reflector and partially backed by the TRC. In one example, the back reflector encompasses approximately 90% of the surface area and the TRC encompasses approximately 10% of the surface area. In another example, the surface area of the back reflector is between about 70-99% of the area, while the TRC makes up about 1-30% of the area. In a further example, the TRC covers at least 20% of the surface area while the back reflector covers no more than 80% of the surface area. The back reflector may be a metal such as aluminum or silver; however, other reflective materials used in PV manufacturing may also be employed. In the example of FIG. 7B, the PV is a non-thin-film PV, which may not absorb all solar radiation on the first pass. The PV benefits from the reflector, which allows for a second pass and more absorption. The TRC does not reflect, which is why a sparse TRC pattern may be advantageous in certain configurations.

Optionally, a thin-film PV cell structure can be backed by a TRC layer, such as shown in FIG. 7C. This primarily drives the thickness of the thin-film layer. For instance, a predetermined portion of the solar spectrum incident should be absorbed within the PV portion of the stack. The thin film can be engineered to absorb all or substantially all solar radiation on the first pass. In one example, the predetermined portion is on the order of 98%. In another example, it is at least 90%. This arrangement is efficient because it can be designed so that everything above the PV bandgap is absorbed, with power generation by the TRC due to Stokes loss in the PV cell structure.

As noted above, intersubband TRC structures may be employed. One example is shown in FIG. 7D. An intersubband TRC is transparent to the radiation absorbed by the PV, and so second pass absorption by the PV is still allowed. Such structures include an asymmetric current transport characteristic, achieved, e.g., with a heterostructure having two different bandgaps on either side of the “junction”, and a heterostructure, e.g. a quantum well, which supports an intersubband optical transition. In one example, the intersubband TRC structure is selected to ensure transparency between the transition edge of the TRC and the absorption edge of the PV. For instance, the bandgap of the PV and the minimum bandgap in the TRC portion are evaluated. To achieve the transparency, in general no layer should have a bandgap smaller than the PV bandgap. However, very thin layers with smaller bandgaps would be acceptable.

Example Methods

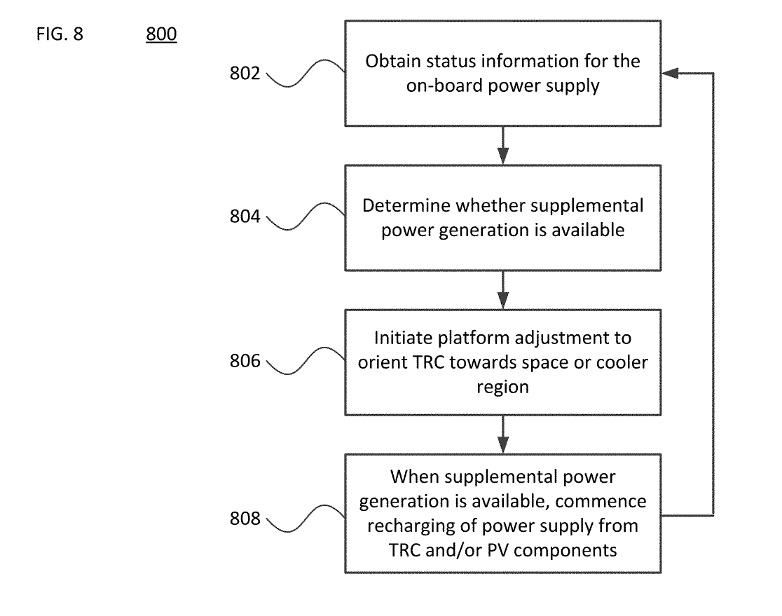

FIG. 8 illustrates an example flow diagram 800 showing on-board recharging using the TRC structures discussed above. For instance, the processors of the control system obtain status information from the on-board power supply at block 802. The processors may poll the power supply, or may receive regular or other updates from the power supply with health status information. At block 804, the control system determines whether supplemental power generation is available. Here, the control system may determine whether there is enough sunlight for the PV cells to generate electricity, or determine that the TRC structures are able to radiate enough heat to space or elsewhere to charge up the power supply. The control system may monitor the amount of available light, the on-board temperature of the TRC structures, the temperature of the surrounding environment and other factors as part of this determination.

As noted above, depending on the configuration employed the TRC structures may always point in a certain direction or have a particular alignment. But in other situations the platform may be adjusted, for instance via a mechanical gimbal or by rotating or otherwise changing the orientation of the platform. Assuming that the platform is capable of such adjustment and that the above determinations have been satisfied, at block 806, the control system initiates a change to orient the TRC structures to efficiently emit heat and generate electricity. Thus, the control system may direct movement of one or more gimbals so that the TRC structures point away from the Earth and towards space.

At block 808, once the system is ready as noted above, the control system commences recharging of the power supply from the TRC structures and/or the PV cells. As shown by the return arrow to block 802, the system may continue to monitor the power supply status in order to determine when to stop recharging or to resume charging at a later time. Optionally, the system may be configured so that in addition or instead of recharging, the supplemental power generation system is able to directly power the payload, communication system and/or control system.

While these processes are shown in the flow diagram in one order, they may be performed in a different order or in parallel depending on system needs or requirements.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A high altitude platform configured to operate in the stratosphere or space, the platform comprising:
a payload;
a power supply coupled to the payload to provide power thereto;
a control system coupled to the payload and the power supply, the control system configured to manage operation of the payload and to manage recharging of the power supply; and
a power generation system coupled to the control system and the power supply, the power generation system comprising a photovoltaic (PV) structure and a thermoradiative cell (TRC) structure, the PV structure being arranged on a panel of the platform, the PV structure being configured to generate power by converting light into electricity, the TRC structure being configured to generate power by radiation of heat into space or the stratosphere.

2. The high altitude platform of claim 1, wherein the PV structure and the TRC structure are disposed on a first side of the panel.

3. The high altitude platform of claim 2, wherein the first side of the panel includes at least one of a photonic crystal structure and a dichroic optical element configured to selectively direct light to one or both of the PV structure and the TRC structure.

4. The high altitude platform of claim 2, wherein the PV structure covers at least 70% of the surface area of the first side of the panel, and the TRC structure covers no more than 30% of the surface area of the first side of the panel.

5. The high altitude platform of claim 2, wherein a first portion of the PV structure is backed by a back reflector and a second portion of the PV structure is backed by the TRC structure.

6. The high altitude platform of claim 2, wherein the PV structure is a thin film PV cell structure, and the TRC structure is arranged on a side of the PV structure opposite from a light receiving side of the PV structure.

7. The high altitude platform of claim 1, wherein the TRC structure is an intersubband TRC structure having an asymmetric current transport characteristic.

8. The high altitude platform of claim 7, wherein the intersubband TRC structure is selected to provide transparency between a transition edge of the intersubband TRC structure and an absorption edge of the PV structure.

9. The high altitude platform of claim 1, wherein the PV structure is disposed on a first side of the panel and the TRC structure is disposed on a second side of the panel opposite the first side.

10. The high altitude platform of claim 9, wherein the control system is configured to manage operation of the power generation system so that during a daylight condition the PV structure is arranged to point in space towards the sun and during a nighttime condition the TRC structure is arranged to point towards space.

11. The high altitude platform of claim 9, further comprising an alignment mechanism, the control system being configured to direct the align mechanism to place the second side of the panel towards space.

12. The high altitude platform of claim 9, wherein the second side of the panel includes one or more low-emissivity regions that intersperse or surround the TRC structure.

13. The high altitude platform of claim 1, wherein the TRC structure and the PV structure comprise a current-matched circuit of the power generation system.

14. The high altitude platform of claim 1, wherein the TRC structure and the PV structure comprise separate circuits of the power generation system, the separate circuits being independently coupled to the power supply.

15. The high altitude platform of claim 1, wherein the TRC structure is indirectly coupled to an external environment.

16. The high altitude platform of claim 15, further comprising an optical fiber that indirectly couples the TRC structure to the external environment.

17. The high altitude platform of claim 16, wherein the TRC structure is selected to have a predetermined optical mode density for coupling via the optical fiber.

18. The high altitude platform of claim 1, wherein the TRC structure is arranged adjacent to at least one of the payload, the control system and the PV structure to operate as a heat sink therefor.

19. The high altitude platform of claim 1, wherein the high altitude platform is selected from the group consisting of a satellite, a high altitude balloon system, a drone and a piloted aircraft.

20. A method of generating power for a high altitude platform, the method comprising:
obtaining, by one or more processors of a control system, status information from an on-board power supply of the high altitude platform;
determining, by the one or more processors, whether supplemental power generation is available from an on-board power generation system coupled to the control system and the power supply, the power generation system comprising a photovoltaic (PV) structure and a thermoradiative cell (TRC) structure, the PV structure being arranged on a panel of the high altitude platform, the PV structure being configured to generate power by converting light into electricity, the TRC structure being configured to generate power by radiation of heat into space or the stratosphere; and
upon determining that supplemental power generation is available, the one or more processors commencing recharging of the on-board power supply from at least the TRC structure of the power generation system.

21. The method of claim 20, further comprising aligning the TRC structure so that a heat emission surface of the TRC structure is directed towards space or otherwise away from a surface of the Earth.
